(19) United States
(12) Patent Application Publication
(10) Pub. No.: US 2026/0071364 A1
(43) Pub. Date: Mar. 12, 2026

(54) MANUFACTUREING METHOD OF LIGHTWEIGHT MELT-BLOWN HOT-MELT NONWOVEN FABRIC COMPRISING HYDROPHOBIC NANO SILICA

(71) Applicants: Heedae PARK, Busan (KR); SAM BU FINE CHEMICAL CO., LTD., Gimhae-si (KR)

(72) Inventor: Heedae PARK, Busan (KR)

(21) Appl. No.: 19/176,936

(22) Filed: Apr. 11, 2025

(30) Foreign Application Priority Data
Sep. 6, 2024 (KR) 10-2024-0121564

(51) Int. Cl. D04H 1/56; C08K 3/36; C08K 9/04; D01D 1/06; D01D 5/098; D01F 1/10; D01F 6/70; D04H 1/551; D04H 1/724

(52) U.S. Cl. CPC D04H 1/565; C08K 3/36; C08K 9/04; D01D 1/065; D01D 5/0985; D01F 1/10; D01F 6/70; D04H 1/551; D04H 1/724; C08K 2201/011; D10B 2331/10; D10B 2401/021; D10B 2401/04

(57) ABSTRACT

The lightweight melt-blown hot-melt nonwoven fabric containing hydrophobic nanosilica according to the manufacturing method of the present invention performs an adhesive function when interposed between adherends such as fabric, even if a smaller amount of adhesive resin is applied than a conventional hot-melt film, it has the effect of saving material costs and energy by about 10 to 50% while ensuring uniformity of adhesive strength for each section, excellent peel strength, and good breathability. As a result, fabric products using the melt-blown hot-melt nonwoven fabric can prevent overflow during the adhesion process and achieve lightness and a soft texture.

### CROSS REFERENCE TO RELATED APPLICATION OF THE DISCLOSURE

The present application claims the benefit from Korean Patent Application No. 10-2024-0121564, filed on Sep. 6, 2024, in the Korean Patent Intellectual Property Office, the disclosure of which is hereby incorporated by reference in their entireties.

### FIELD OF TECHNOLOGY

The present invention relates to a method of manufacturing a lightweight melt-blown hot-melt nonwoven fabric containing hydrophobic nanosilica, and more specifically, to a method of manufacturing a lightweight melt-blown hot-melt nonwoven fabric containing hydrophobic nanosilica. More specifically, when bonding fabrics such as clothing, shoes, bags, etc. through an adhesive resin, the melt-blown method is used. By using manufactured hot-melt nonwoven fabric, it is a hydrophobic material that can save material costs and energy while ensuring uniform adhesion, excellent peel strength, and good breathability even when applying a smaller amount of adhesive resin than existing hot-melt films. It relates to a method of manufacturing lightweight melt-blown hot-melt nonwoven fabric containing nanosilica.

### Background Technologies

Recently, as part of efforts to reduce manufacturing costs and improve quality in industries such as shoes, clothing, and bags, as well as all other industries that require adhesive processes, the sewing process, which requires a lot of manpower, has been reduced or eliminated during the manufacturing process. Attempts are being made. Accordingly, the sewing process, which accounts for a significant portion of the product manufacturing cost, is replaced with the adhesive process to increase production per person and reduce costs by shortening the process time.

In this adhesion process, a liquid adhesive is applied to an adherend such as fabric and then dried to volatilize the solvent or moisture, thereby bonding the fabrics to each other. This has the advantage of reducing the process time and number of workers compared to the sewing process, but to maximize cost savings, instead of using a liquid adhesive, a film-type hot-melt film (hereinafter referred to as ‘hot-melt film’) is used to bond fabrics with a heat press.

The hot-melt film is used in industries such as footwear, apparel, and bags for its eco-friendly properties, convenience, and cost savings, and can be manufactured from thermoplastic resins of various materials such as thermoplastic polyurethane (TPU), polyamide, ethylene vinyl acetate (EVA), and polyester, These hot-melt films have good extrusion workability and are eco-friendly because they do not use solvents, and selecting a material with good adhesion and touch is suitable for securing adhesion with various fabrics.

However, since conventional hot-melt films are usually manufactured with a thickness of 0.2 mm or more to ensure stable adhesion, when the hot-melt film is placed between the fabrics and heat pressed (no-sew press), overflow occurs frequently, and the fabric product becomes heavier and feels stiff to the touch, which is not in line with the trend toward lighter weight development.

The problem with these conventional hot-melt films is that the thickness of the film is thicker than 0.2 mm, but when heat pressing with the thermoplastic hot-melt film inserted between the fabric and the fabric, the amount of hot-melt film is biased toward the fabric with a larger diameter of the hole, so that there is no hot-melt film at the adhesive interface, resulting in poor adhesion

In other words, if a thermoplastic hot-melt film is used to bond different types of fabrics, such as when bonding fabrics with large and small weaving holes, or fabrics with high and low yarn texture density, the heat and pressure of the hot-melt film will cause the hot-melt film to become too biased to one side of the fabric, causing the hot-melt film to melt and flow to the side of the fabric with the larger hole size or the lower yarn texture density, leaving no hot-melt film on the rest of the bonding interface.

In order to improve the above problems, the inventor of the present application researched the thermoplastic polyurethane hot-melt film and its manufacturing method produced by the T-die extrusion method in Korean published patent Application No. 10-2014-0147631 and No. 10-2015-0005092. In addition, through Korean Patent No. 10-138526 invented by the inventor of the present application, by using a thermoplastic hot-melt film for shoes containing 0.1 to 5 phr of nanosilica in a resin composition selected from at least any one of thermoplastic polyurethane (TPU), ethylene vinyl acetate (EVA), polyamide, and polyester, the invention can increase the adhesive strength of the hot-melt film by preventing the thermoplastic hot-melt film from being melted toward one side of the fabric by heat and pressure and being evenly distributed on the surface of the fabric even when the yarn density of the fabric is high or low or the diameter of the fabric weaving hole is large or small during heat press bonding, i.e., No-Sew Press.

In addition, in Korean Patent Nos. 10-2057036 and 10-2440469, by formulating the nanosilica disclosed in the above patents with surface-modified hydrophobic nanosilica, in addition to the advantages of the conventional technology, it is possible to manufacture a hot-melt film with a thinner thickness, which saves material costs and energy, improves productivity by enabling multi-press molding, and also improves product quality by making the fabric applied to it lighter and softer in texture, as well as improving the overflow phenomenon that was a problem in the adhesive process.

On the other hand, according to aspects of the present invention, to improve the problem that the fabric becomes stiff and the adhesive strength for an adhesive section is not consistent when attaching the conventional hot-melt film to the fabric (subject), it was found that when the fabric is bonded using an adhesive sheet in the form of a melt-blown hot-melt nonwoven fabric, much softer texture, uniform adhesion and excellent adhesive strength for adhesive section are achieved even though it used with less a hot-melt adhesive resin. The present invention was completed by developing a method for manufacturing a lightweight melt-blown hot-melt nonwoven fabric containing hydrophobic nanosilica and the product thereof according to aspects of the present invention.

### RELATED ARTS

### Patent Documents

(Patent document 0001) Korean Application Publication No. 10-2014-0147631 (published on Dec. 30, 2014)
(Patent document 0002) Korean Application Publication No. 10-2015-0005092 (published on Jan. 14, 2015)
(Patent document 0003) Korean patent No. 10-1938526 (Issued on Jan. 15, 2019)
(Patent document 0004) Korean Patent No. 10-2057036 (issued on Dec. 18, 2019)
(Patent document 0005) Korean Patent No. 10-2440469 (issued on Sep. 6, 2022)

### CONTENTS OF THE INVENTION

### Problems to be Solved

Aspects of the present invention are to provide a manufacturing process for a lightweight melt-blown hot-melt nonwoven fabric containing hydrophobic nanosilica, and to provide a hot-melt nonwoven fabric made therefrom, which, when interposed between substrates such as fabrics and the like, can be bonded by applying a smaller amount of adhesive resin than a conventional hot-melt film, while securing uniformity of adhesion by section, excellent peeling strength, and good air permeability, thereby reducing material costs and energy, To provide a method for manufacturing a lightweight melt-blown hot-melt nonwoven fabric containing hydrophobic nanosilica that can prevent overflow phenomenon during the bonding process and realize lightweight and soft texture of fabric products.

### Means of Solving the Problem

A manufacturing method for lightweight melt-blown hot-melt nonwoven fabric containing hydrophobic nanosilica according to aspects of the present invention, the method for manufacturing a hot-melt nonwoven fabric using at least one adhesive resin selected from a thermoplastic polyurethane (TPU) and ethylene vinyl acetate (EVA), which contain hydrophobic nanosilica having a particle size of 1 to 100 nm in the range of 0.1 to 5 parts per hundred resin (phr), the method includes the following two steps: a first step of extruding the adhesive resin in an extruder and then melt-spinning the melt-spun fibers through a spinning nozzle to form a melt-blown nonwoven fabric web; and a second step of trimming and winding the melt-blown nonwoven fabric web.

According to a preferred embodiment of the present invention, the fibers forming the melt-blown nonwoven web have an average diameter of 1 to 30 μm, and the weight of the hot-melt nonwoven fabric is formed in the range of 10 to 300 g/m².

Further, the hydrophobic nanosilica may include at least one hydrophobic functional group selected from an alkyl group, a dimethyl group, a trimethyl group, a dimethylsiloxane group, and a methacrylic group on the surface of the particles, wherein the hydrophobic nanosilica forms nanosilica aggregates, having an average aggregate size between 100 and 1200 nm.

In addition, the thermoplastic polyurethane (TPU) adhesive resin may contain a biomass-based thermoplastic polyurethane resin in the range of 20 to 70% by weight, which is manufactured by reacting biomass-derived polyol with a diol-based chain extender and diisocyanate.

### Effects of the Invention

When a lightweight melt-blown hot-melt nonwoven fabric containing hydrophobic nanosilica by the manufacturing method of the present invention is interspersed between substrates such as fabrics and performs an adhesive function, even if a smaller amount of adhesive resin is applied than the conventional hot-melt film, it has the effect of saving material cost and energy of about 10˜50% while securing uniformity of adhesion force by section, excellent peel strength and good breathability, therefore, the fabric product to which the melt-blown hot-melt nonwoven fabric is applied prevents overflow phenomenon during the adhesive process and has the advantage of realizing light weight and soft texture.

### BRIEF DESCRIPTION OF DRAWINGS

FIG. 1 is a flowchart illustrating a method for producing a lightweight melt-blown hot-melt nonwoven fabric containing hydrophobic nanosilica according to an embodiment of the present invention.

FIG. 2 is a diagram illustrating an apparatus for producing a lightweight melt-blown hot-melt nonwoven fabric containing hydrophobic nanosilica according to an aspect of the present invention.

FIG. 3 an image for a microscopic view measurement of the surface of a lightweight melt-blown hot-melt nonwoven fabric containing hydrophobic nanosilica according to an aspect of the present invention.

FIG. 4 is a microscopic view of the surface of a conventional TPU hot-melt film.

FIG. 5 illustrates measuring the sectional adhesion strength of a lightweight melt-blown TPU hot-melt nonwoven and a conventional TPU hot-melt film according to an aspect of the present invention.

### EMBODIMENTS OF THE PRESENT INVENTION

Hereinafter, a method for producing a lightweight melt-blown hot-melt nonwoven fabric containing hydrophobic nanosilica according to the present invention will be described, which is intended to be illustrative enough to enable a person having ordinary knowledge in the technical field to which the present invention belongs to practice the invention with ease, but is not intended to limit the technical ideas and scope of the present invention.

In general, hot-melt adhesives are applied by melting by heat, so the emission of volatile organic solvents is very low, which meets the requirements for eco-friendly adhesives. In addition to the reduction of the emission of volatile organic compounds that are harmful to human health, efforts to prevent global warming have recently been institutionalized from the perspective of environmental protection, and as part of these global efforts, the use of resins with low carbon dioxide emissions, i.e., low Life Cycle Assessment) (LCA) values, is required.

The hot-melt adhesive is a solid material at room temperature, but when heated, it melts into a fluid state and adheres to the substrate, and when the molten hot-melt adhesive is cooled, it returns to its solid form and regains its cohesion. Adhesion is influenced by the funneling effect, in which liquid adhesive flows through holes irregularities, unevenness, and/or roughness, on the surface to increase adhesion, and to utilize this effect, hot-melt adhesive requires sufficient flowability when melted, so it is melted at a high temperature to achieve the appropriate viscosity.

In general, nonwoven fabrics are produced in sheet form through a three-step process of web formation, web bonding, and processing, and the manufacturing process of nonwoven fabrics can be categorized into wet and dry methods depending on the web formation method, and needlepunching, thermal bonding, meltblown, spunlace, and stitchbond methods depending on the difference in web bonding methods.

According to an aspect of the present invention, the lightweight melt-blown nonwoven fabric manufacturing technology for applying the hot-melt adhesive is a process in which polymers capable of forming fibers of thermoplastic resin are spun through a spinneret formed with hundreds to thousands of orifices (for example, it varies depending on the nozzle size, but is equipped with 2,700 spinning nozzles with a width of 1,700 mm), and the polymer extruded by the spinning nozzles is spun on both sides of the spinneret in a molten state. It is a process technology in which ultrafine fibers of several microns in diameter are stacked on a collector by hot air sprayed at high speed to form a self-bonding nonwoven fabric. By combining the lightweight melt-blown nonwoven fabric manufacturing technology with hot-melt adhesive technology containing hydrophobic nanosilica, it is possible to realize features such as uniform adhesion, excellent peel strength, good air permeability, and lightweight and soft texture of the product.

The melt-blown nonwoven fabric as described above can be spun into ultra-fine fibers compared to spunbond nonwoven fabrics, thus enabling excellent flexibility and light weight, and aspects of the present invention solve the problem that fusion between fibers, shot or fly shapes are prone to occur when the molten resin is traction fine-tuned with a high temperature and high speed fluid.

Accordingly, the manufacturing method of lightweight melt-blown hot-melt nonwoven fabrics containing hydrophobic nanosilica of the present invention, the method for manufacturing a hot-melt nonwoven fabric using at least one adhesive resin selected from thermoplastic polyurethane (TPU) and ethylene vinyl acetate (EVA) containing hydrophobic nanosilica having a particle size of 1 to 100 nm in the range of 0.1 to 5 parts per hundred resin (phr), the manufacturing method includes: the following steps: a first step of extruding the adhesive resin from an extruder and then forming the melt-blown nonwoven web by melt-spinning the fibers through a spinning nozzle; a second step of trimming and winding the melt-blown nonwoven web; and a second step of forming the melt-blown nonwoven web. At this time, the winding speed in the second step may vary depending on the weight of the nonwoven web, for example, the winding speed may vary for the weight of the nonwoven web as shown in Table 1 below.

TABLE 1

| weight(g/m²) | Winding speed(rpm) |
|---|---|
| 25 | 12.5 |
| 45 | 8 |
| 75 | 4.8 |
| 95 | 3.9 |
| 120 | 3.2 |
| 145 | 2.6 |

As commonly used in the present invention, the term “nanosilica” refers to silica particles having a primary particle size of 100 nanometers (nm) or less, and “hydrophobic nanosilica” refers to the introduction of hydrophobic functional groups on some or all of the surface of the nanosilica particles. Conventional nanosilica particles have a hydrophilic surface, but the nanosilica of the present invention has hydrophobic functional groups (lipophilic) introduced through a separate surface treatment (or surface modification) to make the surface hydrophobic, thereby improving dispersibility and enhancing the water resistance of the thermoplastic hot-melt adhesive resin itself, thereby increasing its tensile strength. In addition, the term “lightweight” as used in the present invention most preferably refers to a lighter weight than a conventional hot-melt film, and in one example, it may refer to a lighter weight of about 40% or more compared to the conventional hot-melt film.

Furthermore, the term “nanosilica aggregate” as used in the present invention refers to a state in which about 70% or more of the nanosilica primary particles are strongly bound together by physical and chemical action. The nanosilica aggregate is composed of multiple primary particles, and it is difficult to further separate the nanosilica aggregate into smaller entities, i.e., nanosilica particles, within the hot-melt adhesive resin.

A lightweight melt-blown hot-melt nonwoven fabric containing hydrophobic nanosilica according to the invention, wherein the hot-melt nonwoven fabric is prepared using one or more adhesive resins selected from thermoplastic polyurethane (TPU) and ethylene vinyl acetate (EVA), wherein the adhesive resin contains nanosilica including hydrophobic functional groups on the surface in the range of 0.1 to 5 parts per hundred resin (phr), wherein the nanosilica has a primary particle size of 1 to 100 nm.

The hydrophobic functional groups contained on the particle surface of the nanosilica are at least one selected from an alkyl group, a dimethyl group, a trimethyl group, a dimethyl siloxane group, and a methacrylic group, wherein the nanosilica forms nanosilica aggregates, having an average aggregate size in a range of 100 to 1200 nm, such that when the nanosilica aggregates are bonded by a no-sew press operation, the adhesive resin comprising the lightweight melt-blown hot-melt nonwoven fabric has uniform adhesion from site to site as the adhesive resin is appropriately distributed between the fabric and the fabric (adhesive interface) (see Korean Patent No. 10-2057036).

It has been confirmed that when hydrophobic functional groups are introduced to the surface of the nanosilica particles contained in the melt-blown hot-melt nonwoven fabric of the present invention, the dispersibility of the nanosilica is improved, and the water resistance of the hot-melt nonwoven fabric is enhanced and the tensile strength is increased due to the hydrophobic action, thereby reducing the cutting phenomenon that may occur due to moisture in the molding process such as spinning or stretching and improving the molding properties.

The hydrophobic functional groups that can be introduced on the surface of the nanosilica particles can be alkyl groups, dimethyl groups, trimethyl groups, dimethyl siloxane groups, methacrylic groups, and the like. For example, the nanosilica particles used in the melt-blown hot-melt nonwoven fabric of the present invention include dimethyl groups on the surface of the nanosilica particles by treating the nanosilica obtained by controlling the temperature and pressure in the fumed silica manufacturing process with an organosilane compound.

Preferably, the hydrophobic functionalized nanosilica particles have an OH group density of 1.00H/nm³ or less. The OH group density can be measured by methods known in the art, such as reacting the hydrophobic functionalized nanosilica particles with lithium aluminum hydride and measuring the molar absorbance (E) of the OH group stretching vibration band in the free silanol group at 3750 cm⁻¹ using IR spectroscopy.

In the present invention, nanosilica particles into which hydrophobic functional groups are introduced exist as nanosilica aggregates, and they are dispersed in the hot-melt adhesive resin as aggregates that are difficult to separate. The aggregates preferably have an average aggregate size of 100 to 1200 nm, preferably 200 to 500 nm.

If the size of the hydrophobic nano-silica aggregate is 100 nm or more, the nano-silica is well dispersed, but if it exceeds 1200 nm, the thickening effect is reduced and many defects such as cutting occur in the molding process using an extruder. The size of the nanosilica aggregate refers to the length in the long axis direction of the nanosilica aggregate and can often be measured using a transmission electron microscope or the like.

In addition, the average diameter of the fibers, i.e., staple fibers, forming the melt-blown nonwoven web is preferably 1 to 30 μm. As a result, fabric products using lightweight melt-blown hot-melt nonwoven fabric can exhibit a softer texture than fabric products using conventional hot-melt films.

In addition, by adjusting the weight of the hot-melt nonwoven fabric in the range of 10 to 300 g/m² depending on the application to clothing, shoes, bags, etc., the amount of adhesive resin used in conventional hot-melt films containing hydrophobic nanosilica (thickness of 0.1 mm or more) under the same conditions can be reduced to half the amount. However, if the weight of the hot-melt nonwoven fabric exceeds 100 g/m², it is difficult to show a breathable function that is distinctly differentiated from the conventional hot-melt film due to the fusion by the high temperature and high pressure heat press bonding process, but the hot-melt nonwoven fabric has the advantage of dramatically improving the overflow phenomenon of the adhesive resin during the bonding process compared to the conventional hot-melt film, thereby improving the quality performance of the fabric product.

Accordingly, the lightweight melt-blown hot-melt nonwoven fabric containing hydrophobic nanosilica prepared by the method of the present invention can be used when adhesive resin is interposed between fabrics such as clothing or footwear for bonding, by using the melt-blown hot-melt nonwoven fabric, it is possible to apply a smaller amount of adhesive resin than conventional hot-melt films and still obtain uniform adhesion, excellent peel strength, and good breathability, while reducing material costs and energy costs for heat pressing operations by up to 50%. It can also prevent overflowing phenomenon during the bonding process and improve the lightweight and soft feel of fabric products.

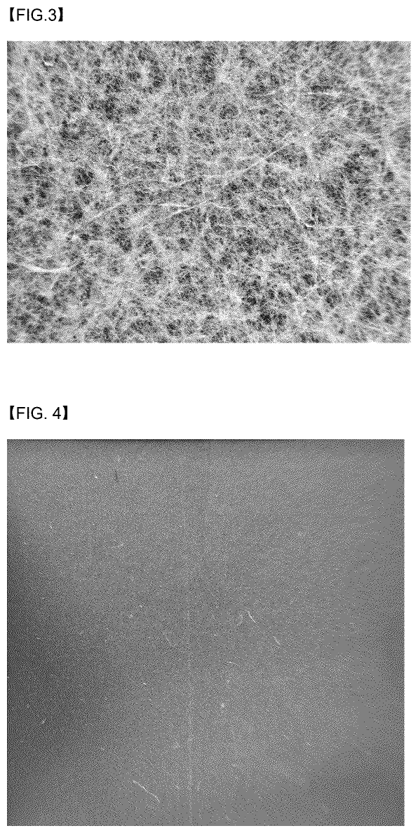

Meanwhile, FIG. 3 is a drawing showing the results of microscopic measurement of the surface of a lightweight melt-blown hot-melt nonwoven fabric containing hydrophobic nano silica according to aspects of the present invention. FIG. 3 is a drawing showing the results of microscopic measurement of the surface of a TPU hot-melt nonwoven fabric containing 1 phr of hydrophobic nano silica having an average particle size (primary particle size) of about 20 nm and including dimethyl groups as hydrophobic functional groups on the surface. FIG. 4 shows a microscopic view of the surface of a conventional TPU hot-melt film, which is a 0.05 mm thick TPU hot-melt film with an average primary particle size of about 20 nm and a 1 phr formulation of hydrophobic nanosilica containing dimethyl groups as hydrophobic functional groups on the surface.

As shown in FIGS. 3 and 4, according to an aspect of the present invention, a lightweight melt-blown TPU hot-melt nonwoven fabric was manufactured to improve the weight and soft feel of fabric products. Based on the TPU resin for the above TPU hot-melt nonwoven fabric, the weight of the lightweight melt-blown hot-melt nonwoven fabric containing hydrophobic nanosilica in the range of 0.1 to 5 phr is formed in the range of 10 to 300 g/m², and the amount of TPU resin used under the same conditions is reduced by about 10 to 50w % compared to the hot-melt film, reducing overflow during no-sew press work. For this reason, it is possible to realize the weight of the fabric product and its soft texture.

As a method of mixing the above hydrophobic nano-silica, In the case of TPU resin, there is a method of mixing nano-silica with raw materials during resin polymerization and then polymerizing to manufacture a hot-melt non-woven resin, or a method of manufacturing a master batch using nano-silica and then mixing the master batch with the TPU resin to manufacture a hot-melt non-woven resin. And in the case of EVA resin, it is convenient to use a method of preparing a masterbatch using hydrophobic nano silica and then mixing the masterbatch with the EVA resin to manufacture a resin for hot-melt nonwoven fabric.

As a result of applying hydrophobic nanosilica with a size of 100 nm or less in a formulation to produce a hot-melt nonwoven fabric, it was confirmed that the adhesion is improved even if a small amount of 0.1 parts per hundred resin (phr) or more is added, and if the content of the nanosilica exceeds 5.0 phr, the surface of the hot-melt nonwoven fabric becomes opaque and the adhesion is reduced, and there is a possibility that the physical properties of the adhesive resin such as blooming phenomenon may occur on the surface of the hot-melt nonwoven fabric over time according to an aspect of the present invention.

When manufacturing a hot-melt nonwoven fabric, according to aspects of the present invention can secure uniform adhesion strength and superior durability than conventional hot-melt films by formulating nanosilica containing hydrophobic functional groups (lipophilic) on the surface as described above to improve dispersibility, enhance water resistance, and increase tensile strength, thereby securing uniform adhesion strength and superior durability with a hot-melt nonwoven fabric with a thinner thickness than conventional hot-melt films, while reducing material costs and energy costs for manufacturing fabric products.

Also, the hot-melt nonwoven fabric may be used for heat press bonding, i.e., No-Sew press, even when the fabric yarn tissue density is high or low, or the diameter of the fabric weaving hole is large or small, the hot-melt nonwoven fabric is not biased to one side of the fabric by heat and pressure, and is evenly distributed on the surface of the fabric, thereby maximizing the adhesion of the hot-melt nonwoven fabric, preventing the fabric from stiffening, and improving the overflow phenomenon caused by the hot-melt nonwoven fabric interposed between the fabrics, thereby providing excellent adhesion performance, Furthermore, it is possible to realize lightweight and soft texture of fabric products with the hot-melt nonwoven fabrics according to aspects of the present invention.

The thermoplastic polyurethane (TPU) used in aspects of the present invention is obtained by polymerizing polyols and isocyanates as raw materials and low molecular weight glycols as chain extenders, wherein examples of polyols used are polyester glycol, polyether glycol, polycaprolactone, etc., examples of isocyanates are aromatic isocyanates, aliphatic isocyanates, etc., and examples of low molecular weight glycols are 1,4-butanediol, etc. In addition, ethylene vinyl acetate (EVA), polyamide, polyester resins, and the like can be used as materials for hot-melt nonwoven fabrics, it was concluded that the use of adhesive resins selected from thermoplastic polyurethane (TPU) and ethylene vinyl acetate (EVA), alone or in combination, is more effective in improving the miscibility, dispersibility, and adhesion performance with hydrophobic nanosilica (see Korean Patent No. 10-2057036).

In particular, the thermoplastic polyurethane (TPU) adhesive resin, which is prepared by reacting a biomass-derived polyol with a diol-based chain extender, diisocyanate, in a range of 20 to 70 wt. %, in order to achieve price stability by using a resource-circulating material in line with green technology due to its environmental and human-friendly properties, has excellent high heat resistance comparable to that of petroleum-based thermoplastic polyurethane resins, elasticity, uniform bond strength and excellent durability (refer to Korean Patent No. 10-2440469), and these positive effects can be achieved in conventional hot-melt films as well as in the lightweight melt-blown hot-melt nonwoven fabrics according to aspects of the present invention.

In the present invention, the biomass-derived polyols used to prepare the biomass-based thermoplastic polyurethane resins are one or more vegetable oil derivatives selected from soybean oil, castor oil, rapeseed oil, sunflower oil, cottonseed oil, sesame oil, coconut oil, and corn oil, peanut oil, safflower oil, palm oil, and at least one derivative of a vegetable oil selected from the group consisting of soybean oil, castor oil, and castor oil, although there is no particular limitation on the specific type of vegetable oil, preferably soybean oil, castor oil is advantageous from an economic point of view.

The aliphatic diol used in the biomass-based thermoplastic polyurethane resin polymerization process has been studied as preferably one or more types of diol selected from ethylene glycol, 1,2-propanediol, 1,3-propanediol, 1,3-butanediol, 1,4-butanediol, 1,5-pentanediol, 1,6-hexanediol, neopentyl glycol, diethylene glycol, triethylene glycol, tetraethylene glycol, dipropylene glycol, and tripropylene glycol.

A thermoplastic polyurethane adhesive resin for hot-melt nonwovens (TPU adhesive resin for hot-melt nonwovens having a biomass-based thermoplastic polyurethane resin in the range of 20 to 70 wt %) is prepared by mixing a biomass-derived polyol and a petroleum-derived polyol in the range of 20 to 70 wt %: 30 to 80 wt % by weight, and then reacted with a diol-based chain extender, a diisocyanate, or, alternatively, 20 to 70 wt % of a biomass-based thermoplastic polyurethane resin prepared by reacting a biomass-derived polyol with a diol-based chain extender and a diisocyanate and 30 to 80 wt % of a petroleum-based thermoplastic polyurethane resin prepared by reacting a petroleum-derived polyol with a diol-based chain extender and a diisocyanate and then mixing the 20 to 70 wt % of the biomass-based thermoplastic polyurethane resin and 30 to 80 wt % of a petroleum-based thermoplastic polyurethane resin according to aspects of the present invention.

As described above, the manufacturing method of lightweight melt-blown hot-melt nonwoven fabric containing hydrophobic nanosilica of the present invention may change the manufacturing process conditions for the conventional melt-blown non-woven fabric according to the type of adhesive resin and the characteristics of the product. The manufacturing method includes: a first step of extruding at least one type of adhesive resin selected from thermoplastic polyurethane (TPU) and ethylene vinyl acetate (EVA) in an extruder, and then forming the melt-spun fibers through a spinning nozzle into a melt-blown nonwoven web; and a second step of trimming and winding the melt-blown nonwoven web.

At this time, the thermoplastic polyurethane (TPU) adhesive resin is melted and spun through the extruder of 130-200° C. and the spinning nozzle of 170-220° C., and the ethylenevinyl acetate (EVA) adhesive resin is recommended to melt and spin through the extruder of 80-170° C. and the spinning nozzle of 130-200° C. The temperature of the extruder and the spinning nozzle needs to be adjusted appropriately within a given range according to the type of adhesive resin.

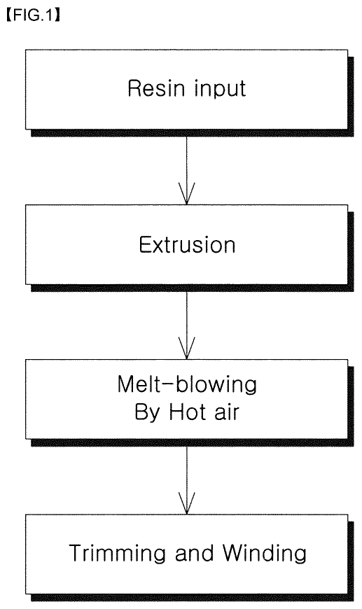

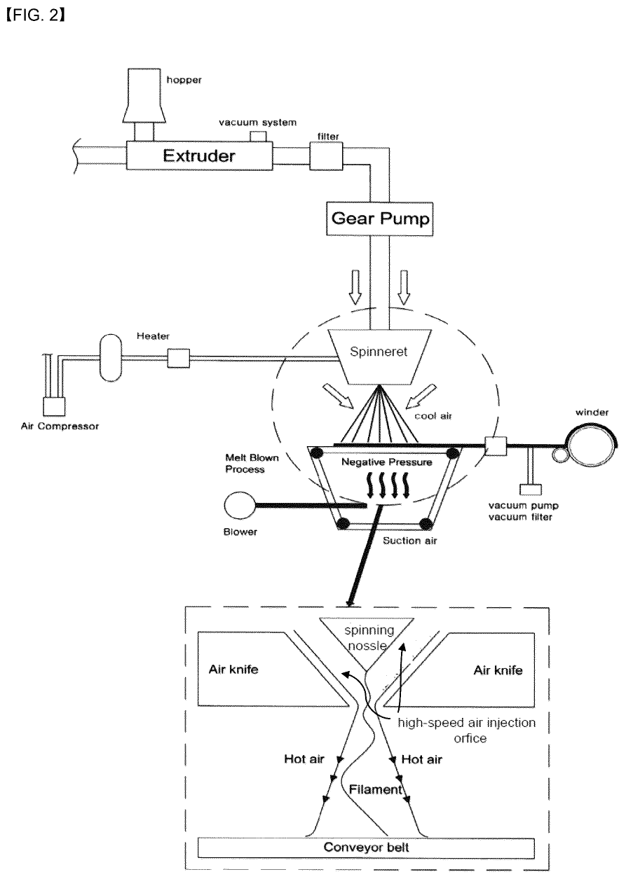

The following describes an experimental embodiment of a melt-blown hot-melt nonwoven fabric (TPU resin) containing hydrophobic nanosilica prepared by the present invention, but the invention is described by means of a preferred embodiment that can be easily practiced by a person having ordinary knowledge in the technical field to which the invention belongs. The following embodiments will be described in more detail with reference to FIGS. 1 and 2. FIG. 1 is a flow chart showing a method for manufacturing a lightweight melt-blown hot-melt nonwoven fabric containing hydrophobic nanosilica according to the present invention, and FIG. 2 is a drawing showing a device for manufacturing the melt-blown hot-melt nonwoven.

### [Example] Manufacture of Lightweight Melt-Blown Hot-Melt Nonwoven Fabrics Containing Hydrophobic Nanosilica

A. Polymer input: TPU resin containing hydrophobic nanosilica is made into small spherical or granular pieces or pellets, poured into a barrel or a hopper, and fed into a screw extruder.

B. Melt extrusion: TPU hot-melt resin chips are put into the screw extruder and extruded at high temperature to become TPU melt resin, and finally the TPU melt resin is sent to the spinneret by the metering pump, for example, a gear pump, after the foreign substances are removed through an ordinary filter.

C. Fiber formation: The clean TPU melt resin filtered through the filter is sprinkled out from each nozzle and sprayed consistently. Unlike other spinning methods, a melt-blown spinneret has the holes of the spinning nozzle arranged in a straight line, and there are high-speed air blast holes at the top and bottom of the spinning nozzle.

D. Fiber cooling: A large amount of room temperature air is sucked in from both sides of the spinning nozzle at the same time, and the spun TPU fibers are mixed with the hot air of the heater, so that the TPU hot-melt non-woven fabric is cooled and solidified.

E. Web formation: In the production of melt-blown TPU hot-melt nonwovens, the spinning nozzles can be placed vertically or horizontally. When placed vertically, as shown in FIG. 2, the spinning fiber falls into the horizontally moving web-forming curtain to form a non-woven web, or when placed horizontally, the spinning fiber can be sprayed into the circular collection drum to form a non-woven web.

F. Trimming and winding: The produced TPU hot-melt non-woven fabric is trimmed to a predetermined desired width, wound, and packaged.

### Experimental Example 1

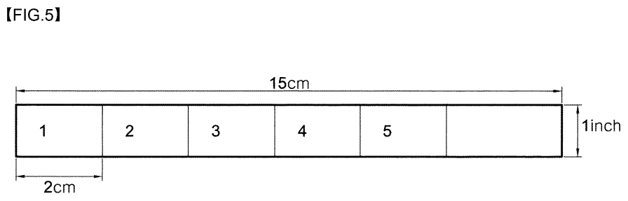

In order to prove the effect on lightweight melt-blown TPU hot-melt non-woven fabrics containing hydrophobic nanosilica, the adhesive strength of each section was measured for the melt-blown TPU hot-melt nonwoven fabric and general TPU hot-melt film manufactured as above. FIG. 5 is a drawing for measuring the adhesion strength of a lightweight melt-blown TPU hot-melt nonwoven fabric and a typical TPU hot-melt film according to aspects of the present invention.

### Subject of Examination

NASA-WEB (TT): lightweight melt-blown TPU hot-melt nonwoven fabric containing hydrophobic nanosilica.
general WEB: TPU hot-melt film without hydrophobic nanosilica (plain WEB).

### Test Method

As shown in FIG. 5, the minimum adhesion strength for the 5 sections is measured by dividing the check section for the adhesion strength in the test specimen of 15 cm in length and 1 inch in width by 2 cm each (this test method applies the NIKE method G44 method).

### Test Conditions

TABLE 2

| Product name | Temperature/Time/Pressure | Net Weight(g/m²) |
|---|---|---|
| NASA-WEB(TT) 45 g | 125° C./20 s/45 bar | 42 |
| general WEB 60 g | 125° C./30 s/45 bar | 62 |

### Test Results (Adhesive Strength: Kg/Cm)

1. NASA-WEB (TT) 45 g

TABLE 3
(L: lenght, W: Width)

| | Direction | MIN | MAX | GAP | AVG | 1 | 2 | 3 | 4 | 5 |
|---|---|---|---|---|---|---|---|---|---|---|
| NO | (L/W) | (A) | (B) | (B − A) | (1~5) | Section | Section | Section | Section | Section |
| 1 | L | 1.02 | 1.09 | 0.07 | 1.06 | 1.08 | 1.09 | 1.05 | 1.07 | 1.02 |
| 2 | L | 0.99 | 1.03 | 0.04 | 1.01 | 1.02 | 0.99 | 0.99 | 1.03 | 1.03 |
| 3 | L | 1.04 | 1.07 | 0.03 | 1.06 | 1.07 | 1.05 | 1.06 | 1.06 | 1.04 |
| 4 | L | 1.07 | 1.10 | 0.03 | 1.08 | 1.09 | 1.07 | 1.08 | 1.10 | 1.07 |
| 5 | L | 1.06 | 1.11 | 0.05 | 1.09 | 1.11 | 1.06 | 1.09 | 1.10 | 1.10 |
| 6 | L | 1.00 | 1.04 | 0.04 | 1.02 | 1.01 | 1.00 | 1.03 | 1.02 | 1.04 |
| 7 | L | 1.11 | 1.15 | 0.04 | 1.12 | 1.15 | 1.11 | 1.11 | 1.12 | 1.12 |
| 8 | L | 1.06 | 1.09 | 0.03 | 1.07 | 1.09 | 1.08 | 1.07 | 1.06 | 1.07 |
| 9 | L | 1.07 | 1.12 | 0.05 | 1.10 | 1.10 | 1.12 | 1.11 | 1.12 | 1.07 |
| 10 | L | 1.10 | 1.15 | 0.05 | 1.13 | 1.12 | 1.10 | 1.13 | 1.13 | 1.15 |
| 11 | L | 1.00 | 1.04 | 0.04 | 1.02 | 1.01 | 1.00 | 1.03 | 1.02 | 1.04 |
| 12 | L | 1.11 | 1.15 | 0.04 | 1.12 | 1.15 | 1.11 | 1.11 | 1.12 | 1.12 |
| 13 | L | 1.06 | 1.09 | 0.03 | 1.07 | 1.09 | 1.08 | 1.07 | 1.06 | 1.07 |
| 14 | L | 1.07 | 1.12 | 0.05 | 1.10 | 1.10 | 1.12 | 1.11 | 1.12 | 1.07 |
| 15 | L | 1.10 | 1.15 | 0.05 | 1.10 | 1.10 | 1.12 | 1.11 | 1.12 | 1.07 |
| 16 | W | 0.97 | 1.03 | 0.06 | 1.01 | 1.03 | 1.00 | 1.03 | 1.00 | 0.97 |
| 17 | W | 0.97 | 1.06 | 0.09 | 1.03 | 1.04 | 1.06 | 1.05 | 1.01 | 0.97 |
| 18 | W | 0.98 | 1.08 | 0.10 | 1.04 | 1.08 | 1.06 | 1.07 | 1.00 | 0.98 |
| 19 | W | 0.96 | 1.05 | 0.09 | 0.99 | 0.98 | 0.98 | 0.96 | 0.97 | 1.05 |
| 20 | W | 1.01 | 1.04 | 0.03 | 1.03 | 1.02 | 1.01 | 1.04 | 1.04 | 1.03 |

2. general WEB 60 g

TABLE 4
(L: Length, W: Width)

| | Direction | MIN | MAX | GAP | AVG | 1 | 2 | 3 | 4 | 5 |
|---|---|---|---|---|---|---|---|---|---|---|
| NO | (L/W) | (A) | (B) | (B − A) | (1~5) | section | section | section | section | section |
| 1 | L | 0.81 | 0.91 | 0.10 | 0.88 | 0.91 | 0.88 | 0.91 | 0.87 | 0.81 |
| 2 | L | 0.80 | 0.95 | 0.15 | 0.88 | 0.95 | 0.90 | 0.89 | 0.87 | 0.80 |
| 3 | L | 0.80 | 0.93 | 0.13 | 0.87 | 0.93 | 0.93 | 0.86 | 0.80 | 0.81 |
| 4 | L | 0.94 | 1.15 | 0.21 | 1.02 | 1.15 | 1.02 | 1.05 | 0.96 | 0.94 |
| 5 | L | 0.78 | 1.02 | 0.24 | 0.88 | 1.02 | 0.91 | 0.84 | 0.78 | 0.86 |
| 6 | L | 0.94 | 1.01 | 0.07 | 0.98 | 0.97 | 0.98 | 1.00 | 1.01 | 0.94 |
| 7 | L | 0.87 | 1.04 | 0.17 | 0.95 | 0.96 | 0.92 | 0.98 | 1.04 | 0.87 |
| 8 | L | 0.83 | 0.97 | 0.14 | 0.92 | 0.95 | 0.92 | 0.97 | 0.94 | 0.83 |
| 9 | L | 1.10 | 1.18 | 0.08 | 1.13 | 1.18 | 1.12 | 1.13 | 1.10 | 1.10 |
| 10 | L | 0.82 | 0.94 | 0.12 | 0.89 | 0.94 | 0.90 | 0.85 | 0.82 | 0.93 |
| 11 | L | 0.99 | 1.10 | 0.11 | 1.03 | 1.03 | 1.02 | 1.10 | 1.02 | 0.99 |
| 12 | L | 0.82 | 1.01 | 0.19 | 0.92 | 0.94 | 1.01 | 0.94 | 0.87 | 0.82 |
| 13 | L | 0.93 | 1.06 | 0.13 | 0.99 | 0.93 | 0.99 | 1.06 | 0.99 | 0.98 |
| 14 | L | 0.96 | 1.06 | 0.10 | 1.01 | 1.06 | 1.02 | 1.01 | 1.01 | 0.96 |
| 15 | L | 0.86 | 0.95 | 0.09 | 0.92 | 0.95 | 0.86 | 0.90 | 0.95 | 0.95 |
| 16 | W | 0.94 | 1.07 | 0.13 | 0.99 | 1.07 | 0.98 | 0.94 | 0.94 | 1.02 |
| 17 | W | 0.94 | 1.02 | 0.08 | 0.97 | 1.02 | 0.94 | 0.99 | 0.97 | 0.95 |
| 18 | W | 0.87 | 0.93 | 0.06 | 0.90 | 0.93 | 0.93 | 0.91 | 0.87 | 0.88 |
| 19 | W | 0.92 | 0.99 | 0.07 | 0.96 | 0.92 | 0.96 | 0.95 | 0.99 | 0.98 |
| 20 | W | 0.88 | 0.94 | 0.06 | 0.91 | 0.93 | 0.88 | 0.88 | 0.93 | 0.94 |

The lightweight melt-blown hot-melt nonwoven fabric (NASA-WEB (TT) 45 g) containing hydrophobic nanosilica as shown in the test results in Table 3 above shows that the deviation of adhesion strength within one specimen is at least 0.03 kg/cm and at most 0.10 kg/cm. On the other hand, the TPU hot-melt film (general WEB) without hydrophobic nanosilica as shown in the test results in Table 4 above has a minimum deviation of 0.07 kg/cm and a maximum of 0.24 kg/cm within one specimen, indicating that the lightweight melt-blown hot-melt nonwoven fabric containing hydrophobic nanosilica according to an aspect of the present invention has less deviation of adhesion strength in each section than the TPU hot-melt film without hydrophobic nanosilica, and thus has excellent uniformity of adhesion.

In addition, fabric products using the lightweight melt-blown hot-melt nonwoven fabric containing the hydrophobic nano-silica have excellent adhesive strength of more than 10% on average even when about 30% less adhesive resin is applied than regular hot-melt films, which not only saves material costs and energy, but also prevents overflow during the adhesive process, makes the product lighter and softer to the touch, and furthermore provides a functional fabric with a moisture-permeable and waterproof function. It is possible to apply thin-thicknessed melt-blown hot-melt nonwoven fabric that can ensure good breathability when bonding or joining.

### Experimental Examples 2

In order to prove the effect on the lightweight melt-blown TPU hot-melt nonwoven fabric containing hydrophobic nanosilica prepared as above, the air permeability of the melt-blown TPU hot-melt nonwoven fabric and the general TPU hot-melt film manufactured as described above was measured.

### Subject of Examination

NASA-WEB (TT): Lightweight Melt-blown TPU Hot-melt Nonwoven Fabric Containing Hydrophobic Nano Silica
NASA-TT 30 μm: TPU Hot-melt Film Containing Hydrophobic Nano Silica

### Test Method

Measurement of the velocity of air flowing perpendicularly through a test specimen under predetermined conditions of area, pressure, and time (KS KISO 9237 method).

### Test Results (Air Permeability: Mm/s)

TABLE 5

| | Non-woven fabric/film | Package after No-Sew |
|---|---|---|
| Product name | only | bonding |
| NASA-WEB(TT) 30 g | 5460~6270 | 61.3~86.7 |
| NASA-TT 36 g | less than1 | less than 1 |

As shown in the test results shown in Table 5 above, the lightweight melt-blown TPU hot-melt nonwoven fabric containing hydrophobic nanosilica (NASA-WEB (TT)) has better air permeability than a TPU hot-melt film containing hydrophobic nanosilica of similar weight (NASA-TT 30 μm), so it can be seen that the lightweight melt-blown hot-melt nonwoven fabric according to the present invention is easy to produce breathable fabric products by adjusting its thickness.

Therefore, the lightweight melt-blown hot-melt nonwoven fabric containing hydrophobic nanosilica prepared according to the present invention, which can be substituted, modified, and altered in various forms without departing from the technical ideas of the present invention, can be applied in various uses and forms as a nonwoven web for adhesion to various textile, leather, and plastic products requiring uniform adhesion and durability, such as sports goods, composite fiber structures, mobile device cases, electronic device housings, automobiles, and home interiors, as well as in the field of fabrics for various shoes, clothing, bags, etc.

1. A method for producing a lightweight melt-blown hot-melt nonwoven fabric containing hydrophobic nanosilica, the method comprising:
a first step of preparing an adhesive resin comprising a resin selected from the group consisting of thermoplastic polyurethane (TPU) and ethylene vinyl acetate (EVA), the adhesive resin further comprising hydrophobic nanosilica with a particle size of 1 to 100 nm in a range of 0.1 to 5 parts per hundred resin (phr);
a second step of extruding the adhesive resin in an extruder and then melt-spinning melt-spun fibers through a spinning nozzle to form a melt-blown nonwoven web; and
a third step of trimming and winding the melt-blown nonwoven web.

2. The method of claim 1, wherein the melt-blown nonwoven web has fibers of an average fiber diameter of 1 to 30 μm.

3. The method of claim 1, wherein the melt-blown hot-melt nonwoven fabric has a basis weight range of 10 to 300 g/m².

4. The method of claim 1, wherein the hydrophobic nanosilica includes at least one hydrophobic functional group selected from an alkyl group, a dimethyl group, a trimethyl group, a dimethyl siloxane group, and a methacrylic group on the surface of the particles of the hydrophobic nanosilica.

5. The method of claim 1, wherein the hydrophobic nanosilica forms nanosilica aggregates which have an average aggregate size averaging-in a range of 100 to 1200 nm.

6. The method of claim 1, wherein the TPU resin comprises a biomass-based thermoplastic polyurethane resin in an amount ranging from 20 to 70 wt % based on total weight of the TPU adhesive resin, prepared by reacting a biomass-derived polyol with a diol-based chain extender, diisocyanate.

7. A lightweight melt-blown hot-melt nonwoven fabric containing hydrophobic nanosilica produced by the method of claim 1.

8. A lightweight melt-blown hot-melt nonwoven fabric containing hydrophobic nanosilica produced by the method of claim 2.

9. A lightweight melt-blown hot-melt nonwoven fabric containing hydrophobic nanosilica produced by the method of claim 3.

10. A lightweight melt-blown hot-melt nonwoven fabric containing hydrophobic nanosilica produced by the method of claim 4.

11. A lightweight melt-blown hot-melt nonwoven fabric containing hydrophobic nanosilica produced by the method of claim 5.

12. A lightweight melt-blown hot-melt nonwoven fabric containing hydrophobic nanosilica produced by the method of claim 6.
